(19) United States
(12) Patent Application Publication
(10) Pub. No.: US 2007/0136655 A1
(43) Pub. Date: Jun. 14, 2007

(54) Method and system for linearly resizing columns in a table

(76) Inventor: Johan C. Peters, Sank Leon-Rot (DE)

Correspondence Address: KENYON & KENYON LLP, ONE BROADWAY, NEW YORK, NY, 10004, US

(21) Appl. No.: 11/302,025

(22) Filed: Dec. 12, 2005

(51) Int. Cl. G06F 17/00

(52) U.S. Cl. 715/509

(57) ABSTRACT

A method and system is provided for resizing columns in a table when a table width is changed from a current table width to a new table width. The table may contain data and may be displayed to a user. The table may be resized responsively to the user's inputs or other conditions. A new column width is determined for each column in the table based on a column minimum width and a column maximum width associated with each column. Column minimum widths and column maximum widths may be selected to enhance user comprehension of data displayed in the table.

### BACKGROUND

Tabular presentation of data in columns is a conventional technique for presenting data in computer applications. Each column may be associated with a column width, and the table may be associated with a table width. Table widths can vary when tabular data is displayed via a user interface that has no fixed width. For example, when displaying a table in a web page via a web browser, the width of an application window assigned to the browser can be controlled by a user. Similarly, table widths may be changed to accommodate different printing scenarios. If a table is printed to a page in portrait orientation, the table width is one size (e.g., 6.5 inches). If the same table is printed in landscape orientation, the table width may be a different size (e.g., 9 inches). The table width also may vary to accommodate changes in paper sizes (legal size, A4 size).

In many applications, such as spreadsheets, word processors and web pages, column widths are defined statically. The applications' user interfaces do not naturally scale the column widths to fit changes in on screen display widths or in rendered display widths (such as on paper). Some rendering systems for web pages may scale all column widths within a table equally in response to changes in the width of the application window. If an application window shrinks to 80% of its former width, all column widths in the table shrink by a corresponding percentage.

Various computing platforms also limit the amount of data that can be displayed intelligibly. A Personal Digital Assistant (PDA) typically has much less screen area than a personal computer (PC). Therefore, different display controls govern from device to device.

Columns in a table may be resized to a width too small or too large to properly display a data. Some types of data should be displayed in columns with specific widths for perceptual quality. For example, if a column displaying a telephone number had its width reduced to the point that trailing telephone digits were truncated, the displayed information would be useless. Alternatively, if the column width increased so that the column width for a telephone number could be increased beyond the size that is necessary to display all digits of the telephone number, providing such an increase in width would be wasteful because there is no other useful information to display. Similarly, it is almost useless to display half a check-box. Information in a check-box or a telephone number column is useful only if the data is displayed in its entirety.

For other types of data, it is possible to shrink the width of a tabular column in which it is displayed without an appreciable loss in perceptual quality. A user may be able to review a portion of the data that remains displayed in the smaller column and perceive useful information. For example, one might gleam useful information from a truncated display of a name or a description.

Therefore, there is a need in the art for a control system for presentation of tabular data that is sensitive to different data types and ensures, where possible, that certain minimum or maximum column widths are maintained.

### BRIEF DESCRIPTION OF THE DRAWINGS

FIG. 1 illustrates an example procedure for resizing a table, in accordance with a first example embodiment of the present invention.

FIG. 1a illustrates an example system architecture configured to execute an example embodiment of the present invention.

FIG. 2 illustrates an example procedure for resizing a table, in accordance with a second example embodiment of the present invention.

FIG. 3 illustrates an example procedure for determining a current table width, in accordance with an example embodiment of the present invention.

FIG. 4 illustrates an example procedure for determining a minimum table width, in accordance with an example embodiment of the present invention.

FIG. 5a illustrates an example column properties table, in accordance with an example embodiment of the present invention.

FIG. 5b illustrates an example column properties table, in accordance with an example embodiment of the present invention.

### DETAILED DESCRIPTION

Embodiments of the invention provide a scheme for resizing column widths dynamically in response to changes in a table width. Each column may have a minimum column width and a maximum column width defined therefor. When the table might be displayed, a user interface may assign column widths dynamically for display of the table. The scheme may changes the width of the columns therein by determining whether the display width is less than the sum of the minimum widths defined for the columns, and if so, allocating display widths to each of the columns equal to their minimum widths. If the display width of the table exceeds the sum of the minimum width of all the columns, the scheme may assign minimum widths to each of the columns and adds to the columns some portion of the slack—a difference between the sum and the table display width—in a predefined order. The table may then be rendered for display using the table widths so calculated.

The scheme may be re-invoked anytime a display width of the table is changed, for example, whenever an application window in which the table sits is resized. In effect, when the width of the table is changed, each column width may be resized. Each column width is kept larger than or equal to the column minimum width and smaller than or equal to the column maximum width.

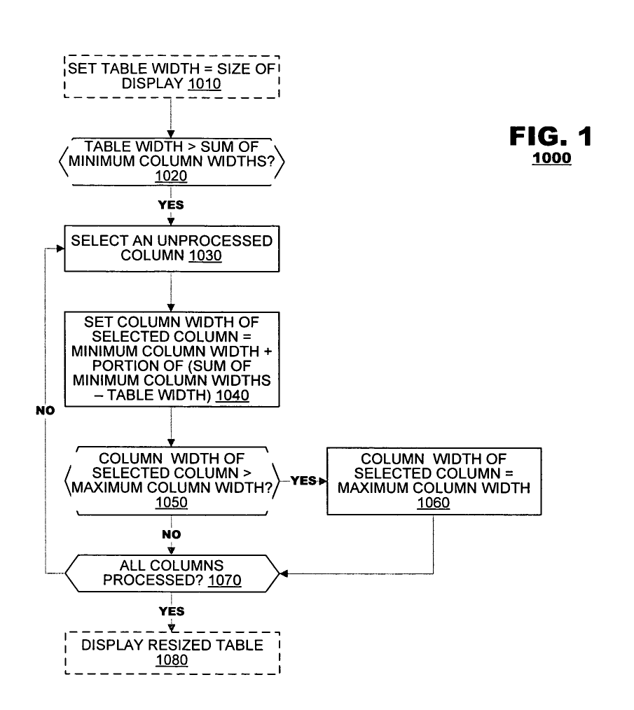

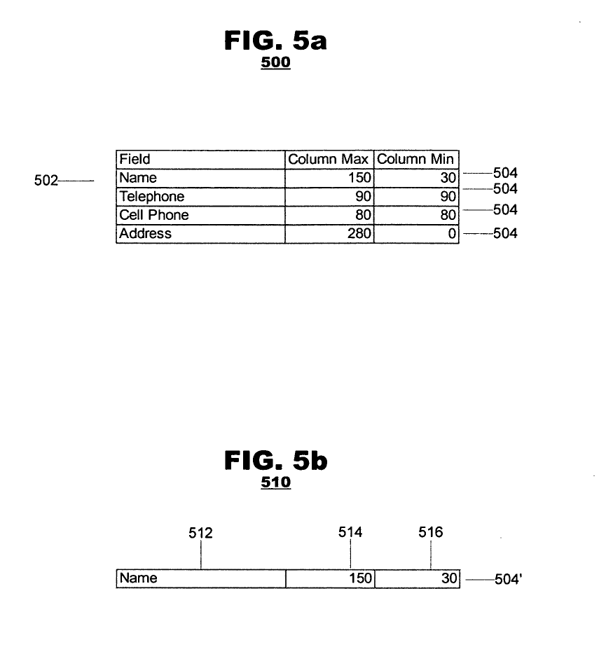

FIG. 1 illustrates an example procedure for resizing a table in accordance with a first example embodiment of the present invention. The table may be associated with a table width and include at least one column. Each column may be associated with a column width. The table width may be a sum of column widths of the columns in the table. Each column also may be associated with a maximum column width and a minimum column width. For example, properties associated with each column may be stored in a column properties table, as illustrated in FIG. 5a and 5b.

In 1010, the procedure may optionally set the table width. For example, the table width may be set as a function of a size of a display where the table is rendered. Alternatively, the table width may optionally be set equal to a size of an application window in which the table is rendered. Alternatively, the table width may optionally be set equal to a user input.

In 1020, the procedure may test whether the table width is greater than a sum of minimum column widths. If no, no resizing may be necessary and the procedure may end. If yes, the procedure may proceed to 1030.

In 1030, an unprocessed column may be selected for processing. The columns may be selected in a predefined order. For example, the columns may be processed in ascending order. In this example, columns may be numbered from left to right in ascending order. Therefore, the columns may be processed from left to right.

In 1040, the column width of the selected column may be set to equal the minimum column width plus a portion of a difference between the sum of minimum column widths and the table width.

In 1050, the procedure may test whether the column width of the selected column set in 1040 is greater than the maximum column width associated with the column. If yes, the procedure may proceed to 1060. If no, the procedure may proceed to 1070.

In 1060, the procedure may set the column width of the selected column equal to the maximum column width. For example, this may prevent a column's column width from exceeding its associated maximum column width.

In 1070, the procedure may test whether all columns have been processed. If yes, the procedure may proceed to 1080. Alternatively, the procedure may end. If no, the procedure may proceed to 1030, where another unprocessed column may be selected for processing.

In 1080, the procedure may optionally display the table with each column associated with its column width set in 1040.

FIG. 1a illustrates an example system architecture configured to execute an example embodiment of the present invention. A terminal 110 may be available to a user. The terminal 110 may include a display screen, an input device such as a keyboard or a mouse, and a network connection. The terminal 110 may also include a processor, the processor configured to execute an application. For example, the terminal 110 may be a personal computer, a laptop computer, a tablet computer, a personal digital assistant (PDA) or a wireless device such as a cell phone.

The terminal 110 may be configured to execute various application programs such as browser programs, word processing programs, spreadsheet programs, presentation generators, enterprise management applications and the like on its processor. For example, a browser 150, such as an Internet web browser may be executed on the terminal 110. These applications may display data tables as part of their ordinary operations. For example, the browser 150 may be configured to display data from a database and accept user input.

A server 120 may be available. In addition, other servers may be available (not depicted). The server 120 may execute software configured to support a database system, as discussed below. The server 120 may include a processor, a database system 130 and a network connection.

There may be a communication link 160 between the terminal 110 and the server 120. For example, the communication link may operably connect the network connection of the terminal 110 and the network connection of the server 120. For example, the communication link 160 may be over the Internet, over a virtual private network, over an Ethernet network, or another conventional network.

The database system 130 may be configured to execute on the server 120. The database system 130 may include a communications manager 140. The communication manager 140 may be configured to execute on the server 120 and to interface with the browser 150 executing on the terminal 110 over the communication link 160. The communication manager 140 may support interactive communications between the browser 150 and the database system 130.

The database system 130 may include a database 134, which may store data. For example, the database 134 may be a relational database. The database system 130 may include a database controller 132. The database controller 132 may be configured to interface between the communication manager 140 and the database 134. For example, the database 134 may be stored on a series of hard disks local to the server 120.

The communication manager 140 may process user requests submitted from the terminal 110 through browser 150. Such requests may be processed through the communication manager 140 and the database controller 130 and may include retrieval of data located in database 134. The data may be returned to the browser 150 and displayed for the user on the browser 150. The user may also submit requests to change viewing parameters, such as resizing the table as displayed on the browser 150.

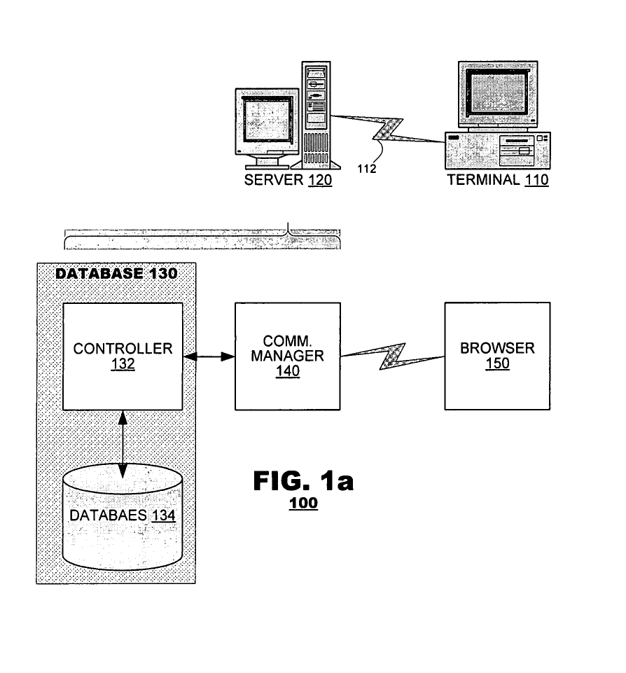

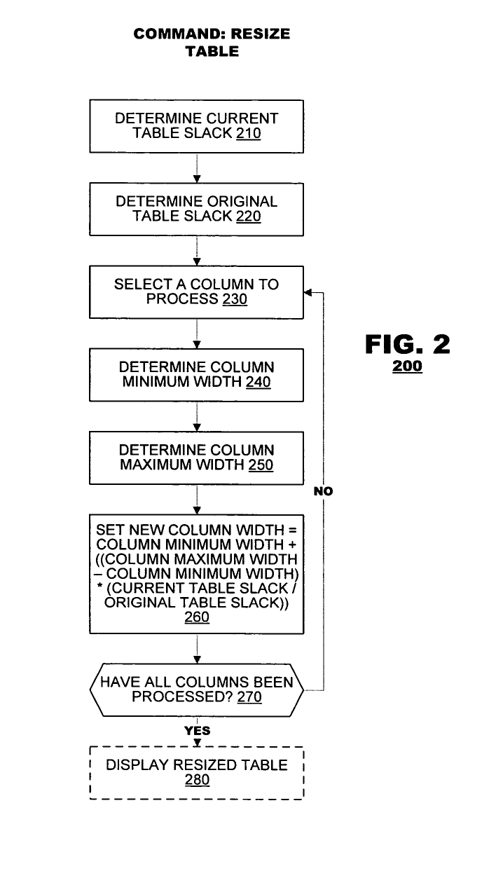

FIG. 2 illustrates an example procedure for resizing a table, in accordance with a second example embodiment of the present invention. The procedure may receive a new table width. For example, the new table width may be a desired table width that is different from a current table width. The new table width may be a size of a display on which the table is rendered. Alternatively, the new table width may be a size of an application window in which the table is rendered. The procedure may be repeated when the application window is resized. Alternatively, the new table width may be a user input value.

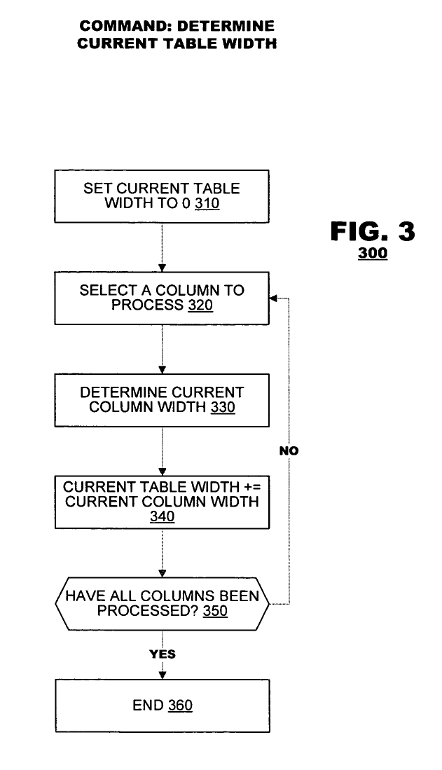

The example procedure may calculate new column widths so that the table may be resized from the current table width to the new table width. The current table width may be determined by the example procedure depicted in FIG. 3.

For example, table and column widths may be a number of characters. That is, a column width may be a number of characters that can fit in the column. Likewise, a table width may be a number of characters that can fit within the table. Alternatively, table and column widths may be a number of pixels or any other absolute or relative unit of measurement.

The new table width may be set to be a minimum of a maximum table width and the received new table width. Thus, the new table width cannot exceed the maximum table width. The maximum table width may be a sum of column maximum widths associated with columns in the table. A column maximum width may be looked up in a column properties table as depicted in FIGS. 5a and 5b.

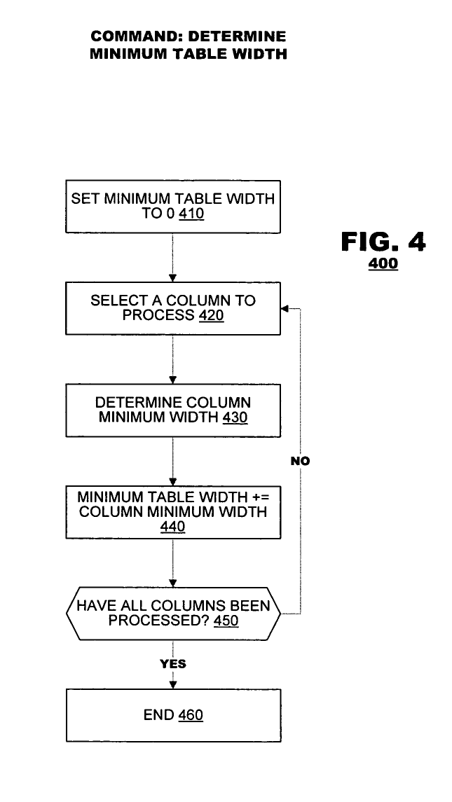

The procedure may begin at 210, where a current table slack may be determined. The current table slack may be set equal to the maximum of zero or a difference between the new table width and a minimum table width. Thus, the current table slack may not be less than zero. The minimum table width may determined by a procedure depicted in FIG. 4. For example, a column minimum width may be pre-defined for each column in the table. For example, the column minimum width may be looked up in a column properties table as depicted in FIGS. 5a and 5b.

In 220, an original table slack may be determined. The original table slack may be a difference between a sum of column maximum widths and a sum of column minimum widths.

In 230, a column may be selected for processing. The column may be selected from the columns of the table in a predetermined order of priority. For example, the columns may be processed in ascending order. In this example, columns may be numbered from left to right in ascending order. Therefore, the columns may be processed from left to right.

In 240, a column minimum width may be determined for the column selected for processing. For example, the column minimum width may be looked up in a column properties table as depicted in FIGS. 5a and 5b.

In 250, a column maximum width may be determined for the column selected for processing. For example, the column maximum width may be looked up in a column properties table as depicted in FIGS. 5a and 5b.

In 260, a new column width may be assigned to the column selected for processing. The column width may be set to equal to a difference between the column maximum width and the column minimum multiplied by the quotient of the current table slack and the original table slack plus the column minimum width. The new column width may be checked to be less than the column maximum width. If the new column width exceeds the column maximum width, the new column width may be set to the maximum column width.

In 270, the procedure may test whether all columns have been processed. If all columns have been processed, the procedure proceeds to 280. If columns remain to be processed, the procedure proceeds to 230.

In 280, the table may be displayed with the new column widths set in 260. For example, the table may be displayed to a user on a browser as depicted in FIG. 1. Alternatively, the procedure may end in 280.

FIG. 3 illustrates an example procedure for determining a current table width, in accordance with an example embodiment of the present invention. In 310, a variable representing a current table width may be set to zero. The current table width may be a width of the table before being resized to a new table width.

In 320, a column may be selected for processing. For example, the columns may be processed in ascending order. In this example, columns may be numbered from left to right in ascending order. Therefore, the columns may be processed from left to right.

In 330, a current column width may be determined. For example, the current column width may be determined by retrieving a property of the column.

In 340, the variable representing the current table width may be incremented by the current column width determined in 330.

In 350, the procedure may test whether all columns have been processed. If all columns have been processed, the procedure proceeds to 360. If columns remain to be processed, the procedure proceeds to 320.

The procedure may end in 360. The variable representing the current table width may be equal to the current table width.

FIG. 4 illustrates an example procedure for determining a minimum table width, in accordance with an example embodiment of the present invention. In 410, a variable representing a minimum table width may be set to zero. The minimum table width may be the minimum width a table may be in accordance with column minimum widths.

In 420, a column may be selected for processing. For example, the columns may be processed in ascending order. In this example, columns may be numbered from left to right in ascending order. Therefore, the columns may be processed from left to right.

In 430, a column minimum width may be determined. For example, the column minimum width may be determined by looking up a column properties table as depicted in FIGS. 5a and 5b.

In 440, the variable representing the minimum table width may be incremented by the column minimum width determined in 430.

In 450, the procedure may test whether all columns have been processed. If all columns have been processed, the procedure proceeds to 460. If columns remain to be processed, the procedure proceeds to 420.

The procedure may end in 460. The variable representing the minimum table width may be equal to the minimum table width.

FIG. 5a illustrates an example column properties table, in accordance with an example embodiment of the present invention. The column properties table 502 may include a plurality of records 504, each record 504 representing one column and a column maximum width and a column minimum width associated with the column.

It will be appreciated that the column properties table 502 may be stored in a variety of ways accessible to a server. For example, it may be stored as a tab delimited or comma delimited flat file, in a relational database or another storage method accessible to a server.

FIG. 5b illustrates an example column properties table, in accordance with an example embodiment of the present invention. Each column properties table entry may be a record 504′. Each record 504′ may contain a variety of information, such as a Field 512. For example, Field 512 may contain a field name associated with each column. The field name may be a string description of data stored in the column. For example, the field name may be “Name”, indicating the column stores a string representing names of people.

The record 504′ may also include a Column Max 514. The Column Max 514 may be a value indicating a column maximum width. For example, the Column Max 514 may be a number indicating how many characters or pixels wide the column may be.

The record 504′ may also include a Column Min 516. The Column Min 516 may be a value indicating a column minimum width. For example, the Column Min 516 may be a number indicating how many characters or pixels wide the column may be.

Several embodiments of the present invention are specifically illustrated and described herein. However, it will be appreciated that modifications and variations of the present invention are covered by the above teachings and within the purview of the appended claims without departing from the spirit and intended scope of the invention.

We claim:

1. A display method for displaying table data in a computing device, comprising:
comparing a table width to a sum of minimum widths defined for all columns of the table;
if the table width exceeds the sum, then in a predetermined order of priority, assigning a display width to a respective column equal to a minimum width defined for the column and a portion of a difference between the sum and the table width; and
displaying the table using the assigned display widths of the columns.

2. The method of claim 1, wherein, if the assigned display width of a column exceeds a maximum width previously defined for the column, then the assigned display width is set to the maximum width.

3. The method of claim 1, wherein the table width is determined by a size of a display on which the table is rendered.

4. The method of claim 1, wherein the table width is determined from a size of an application window in which the table is rendered.

5. The method of claim 4, further comprising repeating the method when the application window is resized.

6. The method of claim 1, wherein the table width is determined from an user input.

7. The method of claim 1, wherein the minimum width, the maximum width of each column is stored in a column properties database.

8. The method of claim 1, wherein the device is a personal computer.

9. The method of claim 1, wherein the device is a personal digital assistant.

10. The method of claim 1, wherein the device is a tablet computer.

11. The method of claim 1, wherein the device is a cellular phone

12. A computer system, comprising:
a display, and
a processor, the processor configured to,
execute an application to display tabular data on the display, and
when a table is to be displayed:
compare a table width to a sum of minimum widths for all columns of the table,
if the table width exceeds the sum, then in a predetermined order of priority, assigning a display width to a respective column equal to a minimum width defined for the column and a portion of a difference between the sum and the table width, and
display the table on the browser using the display widths of the columns.

13. The system of claim 12, wherein, if the assigned display width of a column exceeds a maximum width previously defined for the column, then the processor further configured to set assigned display width equal to the maximum width.

14. The system of claim 12, wherein the application is a browser application.

15. The system of claim 12, wherein the application is a word processing application.

16. The system of claim 12 wherein the application is a presentation generator.

17. The system of claim 12, wherein the application is a spreadsheet.

18. A system of claim 12, wherein the table width is determined by a size of a display on which the table is rendered.

19. A system of claim 12, wherein the table width is determined from a size of an application window in which the table is rendered.

20. A system of claim 19, wherein the processor is further configured to,
repeat the method when the application window is resized.

21. A system of claim 12, wherein the table width is determined from an user input.

22. A system of claim 12, wherein the minimum width and the maximum width of each column is stored in a column properties database.

23. A system of claim 12, wherein the computer system is a personal computer.

24. A system of claim 12, wherein the computer system is a personal digital assistant.

25. A system of claim 12, wherein the computer system is a tablet computer.

26. A system of claim 12, wherein the computer system is a cellular phone.
